(19) United States
(12) Patent Application Publication
(10) Pub. No.: US 2021/0383382 A1
(43) Pub. Date: Dec. 9, 2021

(54) SYSTEMS AND METHODS FOR CUSTOMER CONTROL OF DATA

(71) Applicant: Wells Fargo Bank, N.A., San Francisco, CA (US)

(72) Inventors: David Harris, Huntersville, NC (US); John G. Kolar, San Francisco, CA (US); Michele M. Ladmirault, San Francisco, CA (US); Laura Lee Orcutt, Chanhassen, MN (US); Angela Sicord, San Francisco, CA (US)

(21) Appl. No.: 15/694,080

(22) Filed: Sep. 1, 2017

(51) Int. Cl. G06Q 20/40; G06Q 20/10

(52) U.S. Cl. CPC G06Q 20/405; G06Q 20/1085; G06Q 20/4016

(57) ABSTRACT

A computer-implemented method includes receiving a payment request for a financial transaction and determining whether the financial transaction violates at least one of a hard or soft rule associated with a customer account. The method also includes, in response to determining that the transaction does not violate a hard rule but violates a soft rule, determining whether the financial transaction is low risk and, in response to determining that the financial transaction is low risk, authorizing the payment for the transaction. The method further includes updating the violated soft rule such that future financial transactions similar to the authorized financial transaction do not violate the soft rule.

### TECHNICAL FIELD

Embodiments of the present disclosure relate generally to the field of processing financial transactions.

### BACKGROUND

Many financial transactions are carried out by a customer using a payment device, such as a credit card linked to a credit card account, a debit card linked to a debit card account, or a bank account. The customer provides data about the payment device to a point-of-sale terminal, an online checkout system, an automated teller machine (“ATM”), a peer-to-peer (“P2P”) payment system, and so on, which ultimately provides the payment device data and information about the transaction to the financial institution associated with the payment device. The financial institution may then employ various methods to determine whether the financial transaction is fraudulent in deciding whether to authorize the transaction.

### SUMMARY

One embodiment relates to a computer-implemented method performed by a computing system. The method includes receiving a payment request for a financial transaction, the payment request associated with an account held by a customer at a financial institution, and determining whether the financial transaction violates at least one of a hard rule or a soft rule associated with the customer account. The method also includes, in response to determining that the financial transaction does not violate a hard rule but does violate a soft rule, determining whether the financial transaction is a low risk transaction, wherein a low risk transaction is associated with a low risk of fraud, and in response to determining that the financial transaction is a low risk transaction, authorizing the payment for the financial transaction. The method further includes updating the violated soft rule such that future financial transactions similar to the authorized financial transaction do not violate the soft rule.

Another embodiment relates to a system. The system includes a network interface, an accounts database configured to store account information for a plurality of customers of a financial institution, and one or more processors. The one or more processors are configured for receiving a payment request for a financial transaction, the payment request associated with an account held by a customer at the financial institution, and determining whether the financial transaction violates at least one of a hard rule or a soft rule associated with the customer account. The one or more processors are also configured for, in response to determining that the financial transaction does not violate a hard rule but does violate a soft rule, determining whether the financial transaction is a low risk transaction, wherein a low risk transaction is associated with a low risk of fraud, and in response to determining that the financial transaction is a low risk transaction, authorizing the payment for the financial transaction. The one or more processors are further configured for updating the violated soft rule such that future financial transactions similar to the authorized financial transaction do not violate the soft rule.

Yet another embodiment relates to a computer-implemented method performed by a computing system. The method includes receiving one or more payment rules from a customer for an account held by the customer at a financial institution and receiving an indication from the customer of whether each rule is a hard or a soft rule and, for one or more of the soft rules, customer criteria defining when a transaction violating the soft rule is a low risk transaction. The method also includes receiving a payment request for a financial transaction, the payment request associated with the customer account, and determining whether the financial transaction violates at least one of the hard or soft rules received from the customer for the customer account. The method additionally includes in response to determining that the financial transaction does not violate a hard rule but does violate a soft rule, determining whether the financial transaction is a low risk transaction, based at least partially on the customer criteria for the violated soft rule, wherein a low risk transaction is associated with a low risk of fraud, and in response to determining that the financial transaction is a low risk transaction, authorizing the payment for the financial transaction. The method moreover includes updating the violated soft rule such that future financial transactions similar to the authorized financial transaction do not violate the soft rule.

### BRIEF DESCRIPTION OF THE DRAWINGS

FIG. 1 is a block diagram of a system for customer control of data according to an example embodiment.

FIG. 2 is a flow diagram of a method of processing a payment request for a financial transaction according to an example embodiment.

FIGS. 3A and 3B are interfaces shown on a display of a customer device, including graphics displaying part of a customer profile setup process, according to an example embodiment.

FIGS. 4A and 4B are interfaces shown on a display of a customer device, including graphics displaying a customer profile, according to an example embodiment.

FIGS. 5A and 5B are interfaces shown on a display of a customer mobile device, according to an example embodiment.

### DETAILED DESCRIPTION

Referring to the Figures generally, various systems, methods, and apparatuses for providing customer control of data are described herein. More particularly, systems and methods are described for allowing customers to program payment rules that limit where and how a payment device (e.g., credit card, debit card, bank account for Automated Clearing House (“ACH”)) can be used.

A non-limiting example implementation is described as follows. A customer holding an account with a financial institution, such as a credit card account or a demand deposit account, sets up a profile relating to the account. The profile includes rules limiting when the financial institution should authorize from the account. Example rules include the types of financial transactions that can be carried out using the account (e.g., point-of-sale transactions, mobile wallet transactions, ACH transactions), merchants that transactions can be carried out with, payment amounts that can be authorized from the account, and so on. As an illustration, in one embodiment, the customer sets up a rule indicating that the customer's debit card can only be used at ATMs.

Subsequently, when a payment request for the customer account is received by the financial institution, the financial institution checks with the customer profile to see if the financial transaction associated with the payment request meets the rules set up by the customer as part of the customer profile. If the transaction meets the rules, the financial institution approves the transaction. If the transaction violates a rule, the financial institution determines whether the violated rule is an inflexible rule (“hard rule”) or a flexible rule (“soft rule”). If the transaction violates a hard rule, the financial institution denies the payment for the transaction. On the other hand, if the transaction violates a soft rule, the financial institution determines whether the violation is a minor violation (e.g., the financial transaction is considered a low risk transaction) or a major violation (e.g., the financial transaction is considered a higher risk transaction). For example, in one embodiment, if the transaction within a certain amount over a purchase limit (e.g., within 10% of the purchase limit), the financial institution determines that the violation is a minor violation. By contrast, if the transaction is more than a certain amount over the purchase limit (e.g., more than 10% above the purchase limit), the financial institution determines that the violation is a major violation. In the case of a major violation, the financial institution denies the transaction, whereas in the case of a minor violation, the financial institution approves the transaction. In some embodiments, after deciding whether to deny or approve the transaction, the financial institution takes one or more additional actions, such as sending a notification to the customer asking the customer if the customer was responsible for the transaction.

Embodiments described herein solve the technical problem of improperly denying payments for financial transactions that involve minor violations of transaction limits. Denying transactions that violate limits imposed by a customer can be important for various reasons, such as ensuring the security of the customer's financial account or helping the customer maintain a budget. However, being overly conservative in denying transactions that violate limits, as in denying transactions that violate limits but are low risk (e.g., unlikely to be fraudulent), leads to detrimental delays in processing desired customer transactions or, in some cases, prevents the desired transaction from occurring entirely.

As an illustration, a customer creates a spending limit for a credit card, specifying that a given transaction should be denied if the transaction is more than $100. Later, the customer uses the credit card to purchase an item costing $95. However, when tax is added, the total cost of the item is more than $100. Even though the transaction violates the customer's limit of $100, the transaction cost is still close to the customer's limit and has a low risk of being fraudulent. Accordingly, denying the transaction in this situation not only produces an undesirable result for the customer, who believed that he or she was complying with the transaction limit, but burdens the computer systems involved in processing the transaction. For example, after the transaction is initially denied, the customer may attempt to reuse the payment card multiple times to initiate a transaction payment, which lowers the available computer bandwidth for the computers involved in processing the transaction (e.g., the point-of-sale terminal, computing systems for various financial institutions involved in the transaction) and requires the computer processors to process unnecessary transactions. Checkout line throughput may also be decreased as the customer faces delays in processing the transaction. Further, the customer's financial institution and the individual or merchant involved in the transaction may lose the opportunity to carry out the transaction if the payment card denial cannot be reversed and ultimately prevents the transaction from taking place. As such, including the option for customers to use soft rules for transaction limits, as described herein, addresses these types of issues arising from being overly conservative with denying transactions that violate transaction limit rules. For example, soft limits may prevent the unnecessary denial of transactions, thereby increasing the functionality of the computing systems involved in processing the transaction (e.g., by preventing unnecessary transactions from lowering computer bandwidth and being processed by the computer processors), checkout line throughput, and customer satisfaction.

Furthermore, in some cases, providing customers with options for specifying when a transaction should be denied helps the financial institution better detect fraudulent transactions. For example, if a customer has been a victim of fraud in the past, the customer is likely in the best position to know what a fraudulent transaction is likely to be and set rules that catch those fraudulent transactions. As such, if the customer is able to set soft rules for certain types of transactions and hard rules for other types of transactions, the computing systems associated with the customer's financial institution can more effectively detect fraudulent purchases without denying desired purchases made by the customer.

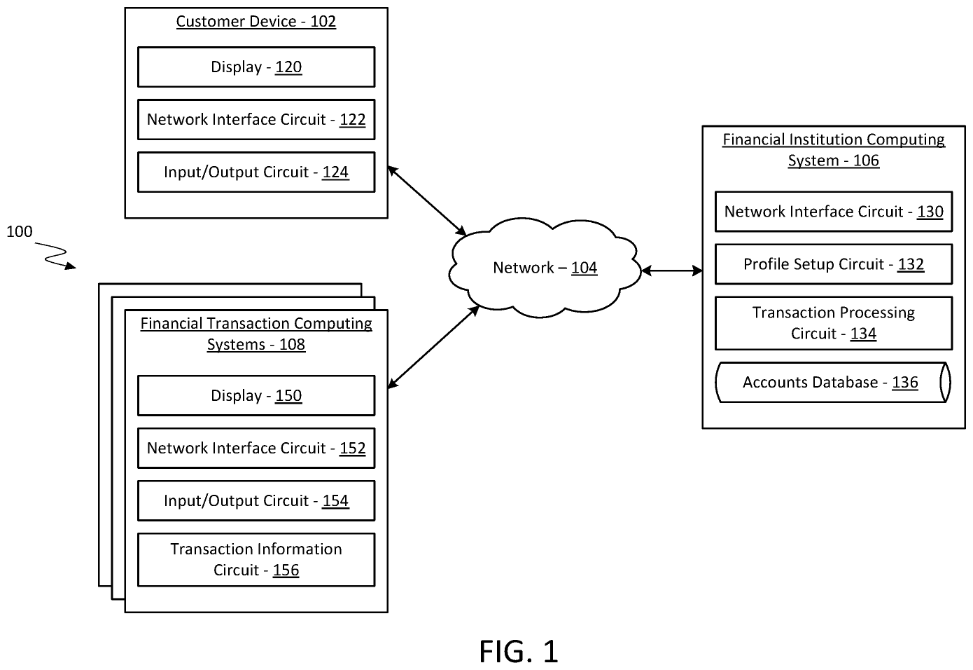

Referring now to FIG. 1, an embodiment of an environment 100 is depicted. In brief overview, the environment 100 includes a customer device 102 used by a customer connected to a network 104. Also connected to the network 104 are a financial institution computing system 106 and one or more financial transaction computing systems 108. In reference to components of the environment 100 described herein, references to the components in singular or in plural form are not intended as disclaimers of alternative arrangements unless otherwise indicated. The components are configured to interact, in various arrangements, as described in further detail below.

In the environment 100, data communication between the customer device 102, the financial institution computing system 106, and the one or more financial transaction computing systems 108 is facilitated by the network 104. In some arrangements, the network 104 includes the Internet. In other arrangements or combinations, the network 104 includes a local area network or a wide area network. The network 104 may be facilitated by short and/or long range communication technologies including Bluetooth transceivers, Bluetooth beacons, RFID transceivers, NFC transceivers, Wi-Fi transceivers, cellular transceivers, wired network connections, etc.

Still referring to FIG. 1, the customer device 102 is a computing device associated with a customer of the financial institution associated with the financial institution computing system 106. The customer device 102 includes one or more circuits that are structured to allow the customer device 102 to exchange data over the network 104, execute software applications, access websites, generate graphical user interfaces, and perform other operations described herein. Accordingly, the customer device 102 includes any type of computing device operated by a customer in connection with services provided by a financial institution. For example, in various embodiments, the customer device 102 is a phone (e.g., a smartphone), a mobile computing device (e.g., a tablet computer, a laptop computer, a personal digital assistant, a portable gaming device), a stationary computing device (e.g., a desktop computer, an ATM), or a wearable computing device (e.g., a smart watch, smart glasses, a smart bracelet). In some arrangements, the customer device 102 is alternatively a computing device associated with the financial institution computing system 106. As an example, the customer device 102 is a computing system at a branch of the financial institution associated with the financial institution computing system 106, which the customer uses to, for example, set up a customer profile as described in further detail below.

As shown in FIG. 1, the customer device 102 includes a display 120, a network interface circuit 122, and an input/output circuit 124. The display 120 is a device used to display information in the form of text, images, video, etc. to the customer. For example, the display 120 is a screen, a touchscreen, or a monitor. In some arrangements, the customer device 102 uses the display to communicate information to the customer (e.g., by displaying the information to the customer on the display 120). In certain arrangements, the customer device 102 additionally uses the display 120 to receive communications from the customer (e.g., through a keyboard provided on a touchscreen of the display 120).

The network interface circuit 122 is programmed to facilitate connection of the customer device 102 to the network 104. As such, using the network interface circuit 122, the customer may communicate with other systems or devices in the environment 100, such as the financial institution computing system 106 and/or one or more of the financial transaction computing systems 108. Data passing through the network interface circuit 122 may be encrypted such that the network interface circuit 122 is a secure communication module.

The input/output circuit 124 is structured to receive from and provide communication(s) to the customer associated with the customer device 102. In this regard, the input/output circuit 124 is structured to exchange data, communications, instructions, etc. with input/output components of the customer device 102. Accordingly, in various embodiments, the input/output circuit 124 includes an input/output device, such as the display 120 or a keyboard. In other embodiments, the input/output circuit 124 includes communication circuitry for facilitating the exchange of data, values, messages, and the like between an input/output device and the components of the customer device 102. In yet other embodiments, the input/output circuit 124 includes machine-readable media for facilitating the exchange of information between an input/output device and components of the customer device 102. In still other embodiments, the input/output circuit 124 includes any of a combination of hardware components, communication circuitry, and machine-readable media.

As described above, the financial institution computing system 106 is associated with a financial institution (e.g., a bank, a credit card issuer, etc.) with which the customer holds one or more accounts (e.g., demand deposit accounts, credit card accounts, etc.). As shown in FIG. 1, the financial institution computing system 106 includes a network interface circuit 130, a profile setup circuit 132, a transaction processing circuit 134, and an accounts database 136. In practice, the financial institution computing system 106 includes server computer systems, for example, comprising one or more networked computer systems. In some embodiments, the network interface circuit 130, profile setup circuit 132, transaction processing circuit 134, and/or accounts database 136 may reside, in part, on different servers in relation to parts of other components or to the whole of a particular component.

The network interface circuit 130 is programmed to facilitate connection of the financial institution computing system 106 to the network 104. As such, using the network interface circuit 130, the financial institution computing system 106 is able to communicate with other systems or devices in the environment 100, such as the customer device 102 and the financial transaction computing systems 108. Data passing through the network interface circuit 130 may be encrypted such that the network interface circuit 130 is a secure communication module.

The profile setup circuit 132 is configured to facilitate a customer in setting up a customer profile for the one or more accounts the customers holds with the financial institution associated with the financial institution computing system 106, including setting up hard and/or soft rules for each account. In various arrangements, the profile setup circuit 132 is configured to interface with the customer device 102 (e.g., via the network interface circuit 130) to facilitate the customer in setting up the customer profile. In one example, the customer uses the customer device 102 to access a webpage associated with the financial institution computing system 106, and the profile setup circuit 132 is programmed to, via the webpage, display visual interfaces to the customer for setting up a customer profile and receive customer input regarding the customer profile. In another example, the customer device 102 includes an application associated with the financial institution computing system 106 (e.g., a mobile banking application), and the profile setup circuit 132 is programmed to interface with the application to display visual interfaces to the customer and receive customer input regarding the setup of the customer profile.

Facilitated by the profile setup circuit 132, the customer can set up various types of payment restrictions and limitations for the customer's one or more accounts as hard and/or soft rules. In some embodiments, the profile setup circuit 132 is programmed to provide the customer with a suite of rules to select from. In other embodiments, the profile setup circuit 132 is programmed to allow the customer more control over the rules the customer can select from (e.g., the profile setup circuit 132 is configured to provide the customer with an input box for inputting a desired rule and match the customer's input rule to the most similar rule stored in a rules database).

As will be understood, the rules that the customer is able to create via the profile setup circuit 132 for the customer's one or more accounts can encompass a variety of restrictions and limitations. In one embodiment, the customer is able to set up rules relating to restrictions on devices that can be used to make payments using the customer's one or more accounts. For example, the customer creates a rule for a payment account specifying that the financial institution computing system 106 should authorize a payment requested from the customer's laptop but deny a payment requested from the customer's phone.

In some embodiments, the customer is able to set up rules relating to restrictions on payment methods for the customer's one or more accounts. As an example, the customer creates a rule for a checking account specifying that the financial institution computing system 106 should authorize payments made via debit card and checks but not via wire transfers. As another example, the customer creates a rule specifying that the financial institution computing system 106 should authorize payments from a customer payment account made via SurePay but not made via PayPal.

In some embodiments, the customer is able to set up rules relating to restrictions on how and where a payment card associated with a customer account can be used (e.g., a rule restricting financial transactions that can be carried out using the payment card associated with the account). For example, for a debit card associated with a checking account, the customer specifies that the only payments the financial institution computing system 106 should authorize are withdrawals made with the debit card from automated teller machines (“ATMs”). As a second example, for a credit card associated with a credit account, the customer specifies that the financial institution computing system 106 should deny cash advance requests made via the credit card at banks or ATMs.

In some embodiments, the customer is able to set up rules relating to restrictions on individuals or merchants to which payments can be made from the customer's one or more accounts. In one example, the customer sets up a rule for a payment account specifying that the financial institution computing system 106 should deny payments made to a particular merchant or a particular class of merchants. In another example, the customer sets up a rule for a payment account specifying that the financial institution computing system 106 should only authorize payments made to a particular merchant or a particular class of merchants.

In some embodiments, the customer is able to set up rules limiting the amount of money that can be spent from the customer's one or more accounts (e.g., payment amounts covering financial transactions). For example, the customer can set up rules limiting the amount of money that can be spent in one transaction, on a single item in a transaction, over a specified period of time, and so on from a particular payment account. Accordingly, the customer specifies that the financial institution computing system 106 should deny payments that violate those rules.

In some embodiments, the customer is able to set up rules relating to the currencies in which that payments can be made from the customer's one or more accounts. In one example, the customer specifies that the financial institution computing system 106 should only authorize payments from a customer payment account made in United States dollars (“USD”), Canadian dollars, and pesos.

In some embodiments, the customer is able to set up rules relating to geographic limitations on payments made from the customer's one or more accounts. For example, the customer specifies that the financial institution computing system 106 should deny payments where the payment was requested in-person (e.g., at a point-of-sale terminal) outside of a certain radius from the customer's home. In another example, the customer specifies that the financial institution computing system 106 should only authorize payments requested at merchant locations within the United States and by online merchants based in the United States.

In some embodiments, the customer is able to set up rules relating to the products or services that the customer can purchase using the customer's one or more payment accounts. In one example, the customer specifies for a payment account that the financial institution computing system 106 should deny payments requested for certain products, such as televisions and computers. In another example, the customer specifies for a payment account that the financial institution computing system 106 should only authorize payments requested for certain products, such as groceries. In a third example, the customer specifies that the financial institution computing system 106 should only authorize payment requested for a particular type of products and services, such as medical and health-related products and services.

Those of skill in the art will appreciate that the above embodiments and examples are meant to be illustrative rather than limiting and that a customer can set up, via the profile setup circuit 132, any number or type of payment restrictions as hard and/or soft rules. Additionally, the customer can combine two or more types of restrictions in a rule. As an example, the customer can limit the amount of money that can be spent from a payment account in a single transaction at a particular merchant. As another example, the customer can set a first limit on the amount of money that can be spent on a first type of product (e.g., groceries) in a given transaction and a second limit on the amount of money that can be spent on second type of product (e.g., office supplies) in a given transaction. As a third example, the customer can limit which merchants payments can be made to outside of a radius from the customer's home (e.g., limiting payments to travel-related merchants, such as hotels and airlines). Moreover, if the customer holds more than one account with the financial institution associated with the computing system 106, the customer can set up the same rules for each account or different rules for each account.

Furthermore, for each rule that the customer sets up via the profile setup circuit 132, the customer can specify, via the profile setup circuit 132, that the rule be a hard or a soft rule. If the customer designates a rule as a hard rule, the financial institution computing system 106 will always enforce the rule, as discussed in further detail below. If the customer designates a rule as a soft rule, when the rule is violated, the financial institution computing system 106 will make a determination of whether the violation is a minor violation (e.g., the violating transaction is a low risk transaction) or a major violation (e.g., the violating transaction is not a low risk transaction). If the violating transaction is low risk, the financial institution computing system 106 will still process the payment for the transaction and, in some embodiments, will take additional actions to ensure that the customer is the person requesting the transaction. However, if the violating transaction is not low risk, the financial institution computing system 106 will enforce the rule similarly to a hard rule.

In some embodiments, the customer only designates, via the profile setup circuit 132, whether a given rule is a hard rule or a soft rule and does not designate which transactions the financial institution computing system 106 should consider major or minor violations. For example, in one embodiment, when the customer is setting up a customer profile via the profile setup circuit 132, the customer checks a box for each rule that the customer creates to designate whether the rule is a hard rule or a soft rule. Accordingly, in these embodiments, the financial institution computing system 106 must independently make the determination of whether a violation of a soft rule is a major or minor violation, for example, using internal limits or risk determination algorithms to determine whether the violating transaction has a low risk of fraud. As an example, the customer creates rules specifying that the payment account cannot be used to make payments from the customer's phone and from the customer's tablet computer. The customer further checks a box identifying the tablet computer rule as a hard rule and checks a second box identifying the phone rule as a soft rule. The financial institution computing system 106 then uses internal logic to determine whether a transaction payment request is likely to be fraudulent and thus a major or minor violation of the phone rule.

In other embodiments, the customer is able to specify, via the profile setup circuit 132, criteria defining what constitutes a major or minor violation for each soft rule. In one embodiment, when the customer is setting up a customer profile via the profile setup circuit 132, the profile setup circuit 132 is programmed to present the customer with options for designating what constitutes a low risk violation of each rule. For example, in various arrangements, the customer is presented with an input box for inputting a “low risk” amount or a percentage (e.g., whereby the customer can specify that transaction payments falling within a certain amount or percentage above a purchase limit rule should be considered low risk); a dropdown menu for selecting an amount, percentage, or category (e.g., whereby the customer can specify that, for a rule limiting which products payments can be made for, certain restricted products should be considered low risk); a search box for searching a database storing different ways the customer can specify that a violating transaction is low risk; and so on. In some arrangements, if the customer does not select any “low risk” options for a given rule, the profile setup circuit 132 is programmed to designate the rule as a hard rule. Conversely, if the customer selects one or more “low risk” options, the profile setup circuit 132 is programmed to designate the rule as a soft rule with the selected option(s) being the low risk threshold(s) for the rule.

In one example, a customer creates a rule specifying that the payment account cannot be used to make payments to certain specified merchants. The customer then uses an input box to specify that any payments made to the specified merchants under $100 should be treated as low risk transactions and accordingly minor violations. In another example, the customer creates a rule specifying that the payment account can only be used to make in-person payments within 50 miles from the customer's home and within 25 miles from the customer's workplace. The customer then selects 20% as a low risk violation threshold from a dropdown menu, thereby designating that payments made between 50 and 60 miles from the customer's home and between 25 and 30 miles from the customer's workplace should be considered low risk violations. The customer also gives the financial institution computing system 106 access to his calendar and specifies that the financial institution computing system 106 should also consider transactions made during times designated on the customer's calendar for travel as minor violations. In a third example, the customer creates a rule specifying that the payment account can only be used to make payments in dollars but specifies with a dropdown menu that payments made in Canadian dollars should be considered low risk transactions.

The transaction processing circuit 134 is configured to receive and process payment requests made by various customers for customer accounts held with the financial institution associated with the financial institution computing system 106. In processing payment requests, the transaction processing circuit 134 is configured to determine whether one or more rules associated with the payment account for which the payment request is being made have been violated. For example, if the customer has a rule for a payment account specifying that payments cannot be made to purchase certain products, the transaction processing circuit 134 is programmed to examine at universal product codes (“UPCs”) or stock keeping units (“SKUs”) sent to the financial institution computing system 106 as part of the payment request to determine if the payment request is for a restricted product.

If the payment request violates a rule for the payment account, the transaction processing circuit 134 is further configured to determine whether the violated rule is a hard rule or a soft rule. In the case of a hard rule, the transaction processing circuit 134 is configured to deny the payment request and, optionally, take one or more actions to determine whether the customer actually was the person requesting the payment. For example, in response to determining that the payment request violates a hard rule, the transaction processing circuit 134 is programmed to flag the payment request transaction as potentially fraudulent and deny the transaction. The transaction processing circuit 134 is further programmed to subsequently alert the customer of the transaction with a notification (e.g., by a text or phone call to the customer device 102, by an email to the customer, by a notification on a mobile banking or mobile wallet application on the customer device 102), and the notification asks the customer if the customer was responsible for the transaction. If the customer indicates that the customer was responsible for the payment request (e.g., by a reply text from the customer device 102, by pressing a button on the customer device 102, by verbally indicating that the customer was responsible via the customer device 102), the transaction processing circuit 134 is programmed to notify the customer to retry the transaction. The transaction processing circuit 134 is programmed to then authorize a payment for the subsequent transaction (e.g., provided that the customer has enough funds left in the payment account or has enough remaining credit). On the other hand, if the customer indicates that the customer was not responsible for the payment request, the transaction processing circuit 134 is programmed to close the payment account as compromised.

Conversely, if the transaction violates a soft rule, rather than immediately denying the payment for the transaction, the transaction processing circuit 134 is configured to determine whether the soft rule violation is a major violation or a minor violation (e.g., whether the transaction is low risk or not). As discussed above, in some embodiments, the customer designates when a given transaction that violates a soft rule should be considered low risk when the customer sets up the customer profile via the profile setup circuit 132. Accordingly, if the customer has designated when a transaction should be considered low risk for the payment account for which the payment request is being made, the transaction processing circuit 134 is programmed to determine whether the transaction is a low risk transaction based on the customer's inputted low risk transaction thresholds or guidelines.

However, if the customer cannot designate or has not designated when a given transaction that violates the soft rule should be considered low risk, the transaction processing circuit 134 is configured to make a determination of whether the payment request is for a low risk transaction. In one embodiment, the transaction processing circuit 134 is configured to base this determination on internal predetermined limits. As an example, the transaction processing circuit 134 is programmed to determine violating transactions that are less than 10% greater than a spending limit soft rule to be minor violations of the rule and violating transactions that are greater than or equal to 10% more than a spending limit to be major violations of the rule. As a second example, if multiple soft rules are associated with a customer account, the transaction processing circuit 134 is programmed to determine a transaction violating only one of the rules to be a low risk transaction but a transaction violating more than one of the rules to be a high risk transaction. In another embodiment, the transaction processing circuit 134 is programmed to use fraud detection logic to determine whether the violating transaction is a low risk transaction. For example, if the violating transaction is a single transaction that is $10 above a spending limit, the transaction processing circuit 134 is programmed to determine that the violating transaction is a low risk transaction. However, if the violating transaction is preceded by multiple, small purchases, the transaction processing circuit 134 is programmed to determine that the violating transaction is likely fraudulent and flags it as a high risk transaction. As another example, if the customer has never before used a credit card outside of the United States and the violating transaction is from Europe, the transaction processing circuit 134 is programmed to determine that the violating transaction is a high risk transaction. Further, in some arrangements, the financial institution computing system 106 bases the determination of whether a transaction is low risk at least partially on whether the customer has been a victim of fraud in the past. For example, the transaction processing circuit 134 is configured to determine that a given transaction is more likely to be a major violation if the customer has reported to the financial institution computing system 106 that the customer is a victim of identity theft.

Alternatively, in certain embodiments, the transaction processing circuit 134 is configured to make the determination of whether the transaction is low risk based both on customer input and on an evaluation of the transaction made by the transaction processing circuit 134. In one example, a financial transaction falls within a designated low risk transaction threshold set by the customer, but the fraud detection logic applied by the transaction processing circuit 134 categorizes the transaction as likely fraudulent. Accordingly, the transaction processing circuit 134 is programmed to flag the transaction as a major violation of the soft rule, despite the fact that the transaction is within the customer-designated low risk threshold.

In various embodiments, if the transaction violating the soft rule is a low risk transaction, the transaction processing circuit 134 is configured to allow the transaction and, optionally, take one or more actions to confirm that the customer actually was the person requesting the payment. For example, in response to determining that the payment request violates a soft rule, the transaction processing circuit 134 is programmed to flag the payment request as potentially fraudulent. However, if the payment request is a low risk transaction, the transaction processing circuit 134 is programmed to approve the transaction. The transaction processing circuit 134 is further programmed to then alert the customer of the transaction by a notification (e.g., by a text or phone call to the customer device 102, by an email to the customer, by a notification on a mobile banking or mobile wallet application on the customer device 102), and the notification asks the customer if the customer was responsible for the payment request. If, within a certain amount of time, the customer indicates that the customer was responsible for the payment request (e.g., e.g., by a reply text from the customer device 102, by pressing a button on the customer device 102, by verbally indicating that the customer was responsible via the customer device 102, by a reply email), the transaction processing circuit 134 is programmed to allow the transaction to post to the customer's account. Alternatively, the transaction processing circuit 134 is programmed to allow the transaction to post to the customer's account if the customer does nothing within a certain amount of time after the notification is sent. On the other hand, if the customer indicates that the customer was not responsible for the payment request, the transaction processing circuit 134 is programmed to prevent the transaction from posting to the customer's account. Instead, because the transaction has already been approved, the transaction processing circuit 134 is programmed to charge the transaction back to the merchant. Additionally, in some embodiments, the transaction processing circuit 134 is configured to send the customer (e.g., by email) documentation to dispute the charge.

Conversely, in various embodiments, if the requested payment is not for a low risk transaction, the transaction processing circuit 134 is configured to treat the payment request as though the payment request violated a hard rule. In other words, the transaction processing circuit 134 is configured to deny the payment request and, optionally, take one or more actions to determine whether the customer was the person actually requesting the purchase payment. Alternatively, in some embodiments, the transaction processing circuit 134 is configured to treat the payment request differently from a hard rule violation. For example, in one embodiment, the transaction processing circuit 134 is programmed to take a step to confirm the customer's identity. If the transaction processing circuit 134 cannot confirm the customer's identity, then the transaction processing circuit 134 is programmed to deny the transaction.

In some embodiments, if the customer notifies the transaction processing circuit 134 that the violating payment request was initiated by the customer (or, alternatively, if the customer does not do anything within a certain amount of time after receiving the notification), the transaction processing circuit 134 is configured to take one or more actions to prevent a similar transaction from being flagged as potentially fraudulent in the future. In some arrangements, the transaction processing circuit 134 is configured to trigger a customer profile update to indicate that this type of transaction is allowed. For example, the transaction processing circuit 134 is programmed to send the customer a second notification (e.g., an email, a text message, a phone call) advising the customer to update his or her customer profile so that transactions like the flagged transaction are not flagged in the future. As another example, the transaction processing circuit 134 is programmed to send the customer an email or a text message with a link that the customer can click on that will direct the customer to a profile update webpage where the customer can update his or her profile. Moreover, in some arrangements, the transaction processing circuit 134 is programmed to suggest an update to the customer profile that will avoid a similar future transaction from being flagged as potentially fraudulent. As an example, if a transaction is flagged as potentially fraudulent because the transaction took place just outside a purchase limit radius, the transaction processing circuit 134 is programmed to recommend that the customer increase the purchase limit radius to include the merchant location at which the customer made the purchase.

In other embodiments, if the customer consistently violates a soft rule, the transaction processing circuit 134 is configured to take one or more actions to update the soft rule. In some arrangements, if the customer has historically violated the soft rule with payment requests, the transaction processing circuit 134 is configured to ask the customer if the customer would like to modify the soft rule. In one example, if the customer consistently (e.g., three times in the past month, ten times since the rule was configured) violates a soft rule that includes a purchase limit because of taxes, the transaction processing circuit 134 is programmed to send a second notification (e.g., an email, a text message, a phone call) to the customer suggesting that the customer increase the purchase limit by 10% to avoid future soft rule violations. In another example, if the customer consistently violates a soft rule by buying a type of product that is excluded by the soft rule, the transaction processing circuit 134 is programmed to send a text message with a link or a push notification to the customer's phone that the customer can click on to approve a modification to the soft rule to include that type of product.

Alternatively, in other arrangements, if the customer has historically violated a soft rule with payment requests, the transaction processing circuit 134 is configured to automatically modify the soft rule such that similar future transactions do not violate the soft rule. For example, in response to the customer violating a purchase limit four times within a two week period, the transaction processing circuit 134 is programmed to automatically increase the purchase limit by 15% and send a notification (e.g., an email, a text message, a phone call) to the customer indicating that the soft rule has been updated. As another example, in response to the customer making a total of ten purchases from a merchant that is excluded by a soft rule, the transaction processing circuit 134 is programmed to automatically update the soft rule to include the merchant. In certain arrangements, the customer is able to provide input to the financial institution computing system 106 indicating whether the customer would like a soft rule to be automatically updated or whether the customer would like to instead be notified with a suggestion to update the soft rule in response to a determination from the transaction processing circuit 134 that the customer has historically violated the soft rule.

Moreover, in some embodiments, the transaction processing circuit 134 is configured to similarly recommend an update to or automatically update a hard rule in response to determining that the customer has historically violated the hard rule. In one example, in response to determining that the customer has broken a hard rule five times by making a payment from a restricted device, the transaction processing circuit 134 either sends a notification to the customer recommending that the customer add the device to the list of approved device or automatically adds the device to the list of approved devices, depending on whether the customer has indicated to the financial institution computing system 106 that hard rule updates should occur automatically.

Additionally, in certain embodiments, when a soft rule is violated, the transaction processing circuit 134 is configured to take one or more actions to verify the customer's identity before authorizing the transaction or allowing the transaction to post to the customer's account. For example, the transaction processing circuit 134 is programmed to send a notification to the customer device 102 asking the customer to provide a biometric (e.g., a fingerprint, a voice sample). The transaction processing circuit 134 is programmed to then compare the received biometric to a biometric template for the customer to verify the customer's identity and then authorizes the transaction. As another example, the transaction processing circuit 134 is programmed to ask the customer via the customer device 102 for a two-factor authentication factor (e.g., a two-factor authentication code, a digital certificate, a password).

The accounts database 136 is configured to retrievably store account information for various customers of the financial institution associated with the financial institution computing system 106. For example, in various embodiments, the financial institution accounts database 136 stores customer biographical information, customer account types, customer account balances, customer account transaction histories, and customer account preferences. Additionally, the accounts database 136 is configured to store customer profile information, including one or more rules (e.g., soft rules, hard rules) created by customers for their accounts. Accordingly, when a customer sets up a profile via the profile setup circuit 132 with one or more rules for each of the customer's accounts, the profile setup circuit 132 is configured to store the information relating to the customer profile in the accounts database 136. Likewise, when the transaction processing circuit 134 receives a payment request, the transaction processing circuit 134 is configured to determine whether the payment request violates one or more rules for the account the payment is being requested from based on the customer profile information stored in the accounts database 136.

As shown in FIG. 1, the environment 100 also includes a plurality of financial transaction computing systems 108. Each financial transaction computing system 108 is associated with a merchant (e.g., a retailer, a wholesaler, a marketplace operator, a service provider), a financial institution (e.g., a bank, a credit card network), a P2P payment network, or any other entity capable of facilitating financial transactions. In operation, each financial transaction computing system 108 calculates a total amount owed by a customer for a financial transaction (e.g., a transaction for goods and/or services, P2P payment, a withdrawal from the customer account) and processes the customer's payment for the transaction. In some arrangements, a financial transaction computing system 108 is a device or computing system configured to facilitate a purchase payment, such as a point-of-sale terminal, a mobile device capable of processing transactions, a computing system running an online checkout system, and so on. In other arrangements, a financial transaction computing system 108 is a device or computing system configured to facilitate a money transfer, such as an ATM, a second financial institution, a wire transfer network, a P2P payment network (e.g., SurePay, Venmo, PayPal), and so on. In certain arrangements, the financial transaction computing system 108 includes the customer device 102 (e.g., the customer device 102 is a smartphone of the customer, which the customer uses to set up a customer profile and make a P2P payment using a P2P payment application in communication with a P2P payment network). For purposes of clarity, FIG. 1 is described with reference to a single financial transaction computing system 108, but it should be understood that multiple computing systems 106 may be part of the environment 100.

In various embodiments, each financial transaction computing system 108 includes a display 150, a network interface circuit 152, an input/output circuit 154, and a transaction information circuit 156. The display 150 is a device used to display information in the form of text, images, video, etc. to the customer and/or to an individual facilitating the customer in making a payment (e.g., an employee of a merchant). For example, the display 150 is a screen, a touchscreen, or a monitor. In some arrangements, the financial transaction computing system 108 uses the display 150 to communicate information to the customer and/or the facilitating individual (e.g., by displaying the information to the customer and/or the facilitating individual on the display 150). In other arrangements, the financial transaction computing system 108 additionally uses the display 150 to receive communications from the customer and/or the facilitating individual (e.g., through a keyboard provided on a touchscreen of the display). However, in some embodiments, the financial transaction computing system 108 does not include a display. For example, if the financial transaction computing system 108 is a computing system running an online checkout system, the financial transaction computing system 108 does not include a display and rather interfaces via the network interface circuit 152 with a device associated with the customer (e.g., the customer device 102) to display user interfaces to the customer (e.g., on the display 120).

The network interface circuit 152 is programmed to facilitate connection of the financial transaction computing system 108 to the network 104. As such, the financial transaction computing system 108 is programmed to communicate with other systems or devices in the environment 100, such as the customer device 102 and/or the financial institution computing system 106. Data passing through the network interface circuit 152 may be encrypted such that the network interface circuit 152 is a secure communication module.

The input/output circuit 154 is structured to receive from and provide communication(s) to the customer and/or the individual facilitating the customer in making a payment. In this regard, the input/output circuit 154 is structured to exchange data, communications, instructions, etc. with input/output components of the financial transaction computing system 108. Accordingly, in various embodiments, the input/output circuit 154 includes an input/output device, such as the display 150 or a keyboard. In other embodiments, the input/output circuit 154 includes communication circuitry for facilitating the exchange of data, values, messages, and the like between an input/output device and the components of the financial transaction computing system 108. In yet other embodiments, the input/output circuit 154 includes machine-readable media for facilitating the exchange of information between an input/output device and components of the financial transaction computing system 108. In still other embodiments, the input/output circuit 124 includes any of a combination of hardware components, communication circuitry, and machine-readable media. Additionally, in certain arrangements, the input/output circuit 154 is configured to interface, via the network interface circuit 152, with remote input/output components that are not part of the financial transaction computing system 108 in receiving from and providing communication(s) to the customer and/or the facilitating individual. For example, if the financial transaction computing system 108 is a computing system operating an online checkout system, the input/output circuit 154 is configured to facilitate the exchange of information between input/output components of a device associated with the customer (e.g., the customer device 102).

The transaction information circuit 156 is configured to gather transaction information and payment information from the customer and/or the facilitating individual. In some embodiments, transaction information includes information about goods and/or services the customer is purchasing, the prices of the goods and/or services the customer is purchasing, return policies for goods the customer is purchasing, and so on. For example, if the financial transaction computing system 108 is a point-of-sale terminal, the transaction information circuit 156 is programmed to receive barcode information from the input/output circuit 154 and use the barcode information to identify transaction information relating to products the customer wishes to purchase. In other embodiments, transaction information is simply the amount of the payment, such as when the customer is making a cash withdrawal at an ATM or making a P2P payment.

In various embodiments, the payment information includes a card number for a payment card, an expiration date for a payment card, a card verification code (“CVC”) for a payment card, and so on. The financial transaction computing system 108 receives the payment information by the customer swiping a payment card through a magnetic stripe reader of the computing system 108, inserting a chip of a payment card into a chip reader of the computing system 108, using a mobile wallet (e.g., via the customer device 102), manually inputting payment information into a website, and so on. After gathering the transaction information and payment information, the transaction information circuit 156 is further configured to transmit the transaction and payment information to the financial institution computing system 106 (e.g., based on an issuer identification number (“IIN”) included with the payment information), where the financial institution computing system 106 processes the payment request as discussed above.

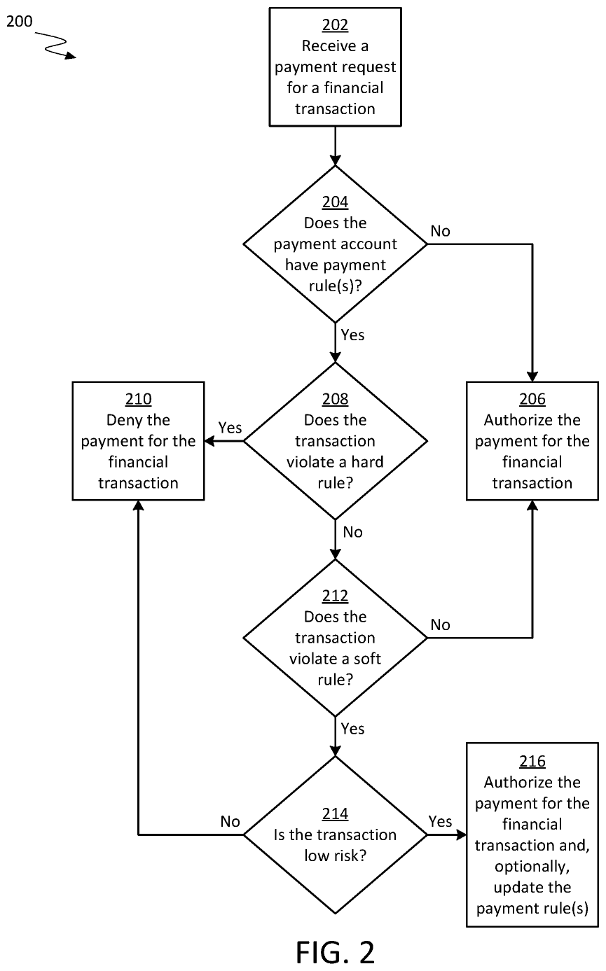

Referring now to FIG. 2, a flow diagram of a method 200 of processing a payment request for a financial transaction is shown according to an example embodiment. The method 200 is performed by a computing system (e.g., a transaction processing circuit 134 of the financial institution computing system 106). The method 200 begins when the financial institution computing system 106 receives a payment request for a financial transaction at 202. The financial institution computing system 106 receives the payment request from a customer via a financial transaction computing system 108 (e.g., a point-of-sale terminal, a computing system operating an online checkout system, an ATM, the customer device 102), with the customer requesting that a payment be made from a payment account the customer holds at the financial institution associated with the financial institution computing system 106.

A determination of whether the payment account has one or more associated payment rules is made at 204. In various embodiments, the contents of the accounts database 136 are examined to determine whether the customer has created a customer profile via the profile setup circuit 132 that includes one or more payment rules for the payment account from which the customer is requesting that a payment be made. If the payment account does not have one or more payment rules, the method comprises authorizing the payment for the financial transaction at 206 (e.g., subject to a determination that the customer has enough funds or credit in the payment account to cover the financial transaction amount).

If the payment account does have one or more payment rules, a determination of whether the transaction violates a hard rule for the account is made at 208. In doing so, a first determination is made whether the payment account has any associated hard rules. If the payment account has one or more hard rules, the financial transaction information received from the financial transaction computing system 108 is examined to determine whether the financial transaction associated with the payment request violates a hard rule. For example, a determination is made whether the financial transaction violates a hard rule based on the financial transaction amount, products or services that the customer will be purchasing in the financial transaction, information about a payment card being used to make the payment request, information about a merchant that the customer is making the purchase from, the currency of the financial transaction, and so on. In some embodiments, data about the financial transaction computing system 108 itself is also examined, such as the identity and geographic location of the financial transaction computing system 108. Additionally, in some embodiments, data is examined about a customer device in communication with the financial transaction computing system 108, such as a laptop the customer is using to make an online payment or a mobile device with a mobile wallet that the customer is using to make a mobile wallet payment. Furthermore, in certain embodiments, the method comprises interfacing with the customer device 102 in determining whether the financial transaction violates a hard rule. In one example, the customer gives the financial institution computing system 106 permission to access various functionalities of the customer device 102, and global positioning system (“GPS”) functionalities of the customer device 102 are used to determine a location of the customer making the financial transaction.

If the transaction violates a hard rule, the payment for the financial transaction is denied at 210. As discussed above, in some embodiments, if the transaction violates a hard rule, the method comprises additionally taking one or more actions to determine whether the customer was actually the person requesting the payment. For example, the customer is sent a text or an email asking the customer if the customer was responsible for the payment request. If the customer indicates that the customer was responsible for the payment request, the customer is notified to retry the transaction, and a subsequent payment request is authorized. If the customer indicates that the customer was not responsible for the payment request, the customer's account is closed. On the other hand, if the transaction does not violate a hard rule (e.g., a determination is made that the payment account has no associated hard rules or that no hard rule is violated), the method comprises determining whether the transaction violates a soft rule for the account at 212. In various embodiments, this determination is made similarly to the determination of whether the transaction violates a hard rule for the account.

If the transaction does not violate a soft rule, the payment for the financial transaction is authorized at 206 (e.g., subject to a determination that the customer has enough funds or credit in the payment account to cover the financial transaction amount). Alternatively, if the transaction violates a soft rule, a determination of whether the transaction is a low risk transaction (e.g., a minor violation, as opposed to a major violation, of the soft rule) is made at 214. In various embodiments, as discussed above, the method comprises determining whether the transaction is low risk based on input from the customer (e.g., a designation of low risk transaction limits inputted by the customer as part of the customer profile) and/or based on an evaluation of the transaction (e.g., using fraud detection logic). If the transaction is determined to be not to be low risk, the payment is denied at 210. Otherwise, if the transaction is determined to be low risk, the payment for the transaction is authorized at 216.

Moreover, if a payment for the financial transaction is authorized, the payment rule(s) associated with the financial transaction are optionally updated at 216. In some embodiments, the method comprises updating the payment rule(s) in response to the customer making an affirmative indication to the financial institution computing system 106 that the customer was responsible for the violating transaction. In other embodiments, the method comprises updating the payment rule(s) in response to the customer not taking any actions (e.g., not reporting the transaction as fraudulent to the financial institution computing system 106) within a certain period of time after the payment was authorized. Additionally, in certain arrangements, the payment rule(s) are automatically updated, while in other arrangements, a notification is sent to the customer recommending that the customer update the payment rule(s), and the customer is responsible for updating the payment rule(s). Further, as discussed above, in some arrangements, the method comprises determining whether the payment rule(s) should be updated whenever a transaction violates the payment rule(s) but is later authorized. Alternatively, in other arrangements, the method comprises determining whether a given payment rule should be updated in response to the payment rule being historically violated (e.g., violated a certain number of times within a given time period) but later authorized.

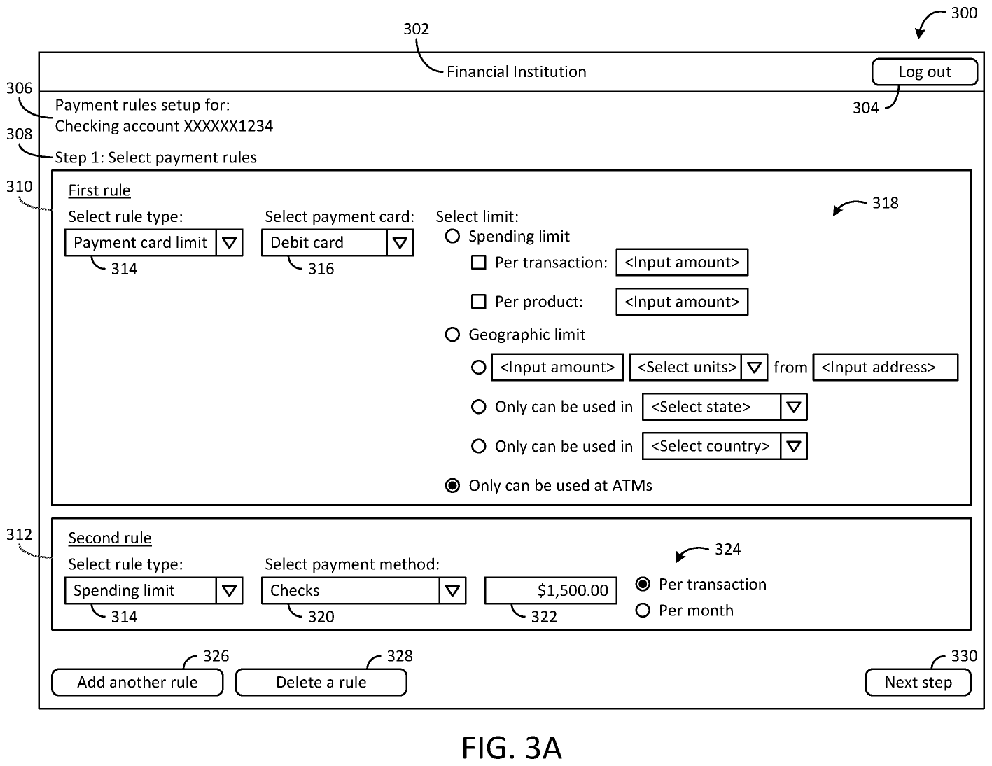

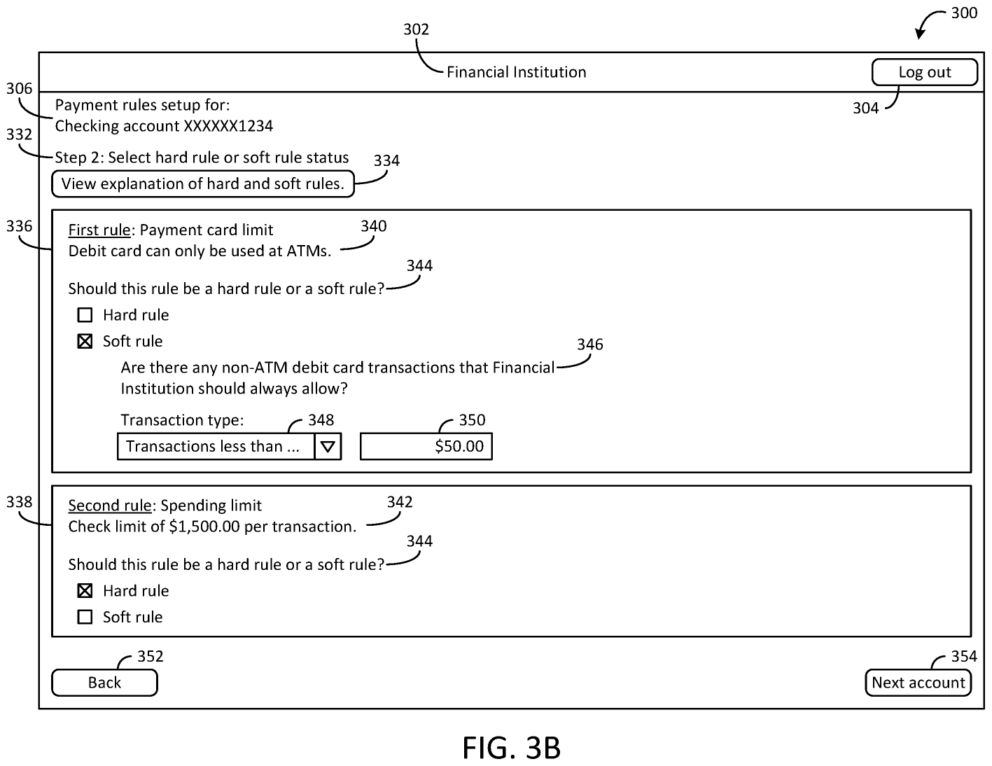

Referring now to FIGS. 3A and 3B, an interface 300 shown on the display 120 of the customer device 102, including graphics displaying part of a customer profile setup process, is shown according to an example embodiment. As shown, the interface 300 is provided by a financial institution 302 (i.e., the financial institution associated with the financial institution computing system 106) with which the customer holds one or more financial accounts. In the example of FIGS. 3A and 3B, the customer has logged into a computing system associated with the financial institution 302 (e.g., a website or banking application associated with the financial institution 302), as shown by a button 304 indicating that the customer can “log out” of the computing system. However, it should be understood that, in other embodiments, the customer profile setup process does not involve the customer logging into a computing system associated with the financial institution 302. As an example, the customer sets up the customer profile at a computing system situated at a local branch of the financial institution 302, and in order to make changes to the customer profile, the customer must revisit a branch of the financial institution 302.

In FIGS. 3A and 3B, the interface 300 displays screens 306 related to a payment rules setup process for a checking account held by the customer. Referring first to FIG. 3A, the payment rules setup screen 306 is directed to a first step of the payment rules setup process and accordingly includes a page 308 for the customer to select payment rules for the customer's checking account. In turn, the payment rules selection page 308 includes a first rule section 310 and a second rule section 312 in which the customer has specified a first rule and a second rule, respectively, for the checking account. As shown, the first rule section 310 and the second rule section 312 each includes a dropdown menu 314 where the customer can select a payment rule type. In the example of FIG. 3A, the customer has selected a “payment card limit” as the first rule in the first rule section 310 and a “spending limit” as the second rule in the second rule section 312. Accordingly, the sections 310 and 312 have been populated with different options for the customer to select based on the fact that the customer has selected different rule types in sections 310 and 312.

Looking first to the first rule section 310, the customer has been presented with a second dropdown menu 316 for selecting a payment card associated with the customer's checking account to which the payment card limit should be applied. In the example of FIG. 3A, the customer has selected that the payment card limit should be applied to a “debit card.” Accordingly, the customer has also been presented with a subsection 318 containing different options for selecting the spending limit for the debit card. The spending limit subsection 318 includes three radio buttons. A first radio button allows the customer to select a spending limit for the debit card and further includes check boxes and input boxes for allowing the customer to select and input (a) a per transaction spending limit and/or (b) a per product spending limit. A second radio button allows the customer to select a geographic limit for the debit card and further includes radio buttons, input boxes, and dropdown menus for allowing the customer to select (a) a radius from a particular address in which the debit card can be used, (b) a state in which the debit card can be used, or (c) a country in which the debit card can be used. A third radio button allows the customer to select that debit card transactions only be allowed from ATMs. In the example of FIG. 3A, the customer has selected this third radio button option.

Looking next to the second rule section 312, the customer has been presented with a second dropdown menu 320 for selecting a payment method to which the spending limit should be applied. In the example of FIG. 3A, the customer has selected “checks” as the payment method. Accordingly, the customer has also been presented with an input box 322 for inputting a spending limit for checks from the customer's checking account and radio buttons 324 for selecting whether the spending limit should be applied “per transaction” or “per month.” In the example of FIG. 3A, the customer has inputted a spending limit of $1,500.00 and selected that the limit should be applied per transaction.

The payment rules selection page 308 further includes an “Add another rule” button 326 and a “Delete a rule” button 328. As such, the customer can add further rules by pressing the button 326 (e.g., if the customer selects the button 326, the customer is presented with a third rule subsection with a “select rule type” dropdown menu, similar to sections 310 and 312). The customer can also delete the first or second rule by selecting the button 328 (e.g., if the customer selects the button 328, the customer is given the option of selecting the first rule section 310 or the second rule section 312 such that the selected section is deleted). In FIG. 3A, the payment setup screen 306 also includes a “Next step” button 330 that the customer can press to move to the next step of the payment rules setup process. For example, if the customer presses the button 330, the customer is directed to the interface 300 shown in FIG. 3B.

Referring now to FIG. 3B, the payment rules setup screen 306 is directed to a second step of the payment rules setup process and accordingly includes a page 332 for the customer to select whether each rule selected in the first step of the process (e.g., as shown in FIG. 3A) is a hard or soft rule. To that end, the hard/soft rules selection page 332 includes a “View explanation of hard and soft rules” button 334 that the customer can press to view an explanation of what a hard rule is and what a soft rule is.

As shown, the hard/soft rules selection page 332 includes a first rule section 336 and a second rule section 338, with the sections 336 and 338 corresponding to the first rule and the second rule selected by the customer, respectively, in the payment rules selection page 308 shown in FIG. 3A. Accordingly, the first rule section 336 includes a subsection 340 summarizing the first rule selected by the customer (“Debit card can only be used at ATMs.”), and the second rule section 338 includes a subsection 342 summarizing the second rule selected by the customer (“Check limit of $1,500.00 per transaction.”). Each section 336 and 338 also includes a subsection 344 asking the customer if the rule associated with the section 336 or 338 should be a hard rule or a soft rule and including check boxes for the customer to select whether the rule should be a hard or soft rule.

In the example of FIG. 3B, in the first rule section 336, the customer has selected that the first rule should be a soft rule. Accordingly, the customer has also been presented with a subsection 346 for selecting a type of non-ATM debit card transactions that the financial institution 302 should always allow, or in other words, transactions that the financial institution 302 should consider to be minor violations. In FIG. 3B, the low risk selection subsection 346 includes a dropdown menu 348 for selecting a transaction type, in which the customer has selected “Transactions less than . . . ” As such, the customer has also been presented with an input box 350 in the low risk selection subsection 346 for inputting a payment limit under which transactions should be considered low risk. As shown, the customer has input $50.00 in the input box 350. Conversely, in the second rule section 338, the customer has selected that the second rule should be a hard rule and is accordingly not presented with any further options.

Additionally, in FIG. 3B, the hard/soft rules selection page 332 includes a “Back” button 352 that the customer can press to return to view the payment rules selection section 308 (e.g., as shown in FIG. 3A). The hard/soft rules selection page 332 also includes a “Next account” button 354 that the customer can press to finalize the rules for the checking account and subsequently select rules for another of the customer's accounts at the financial institution 302. In some embodiments, interfaces shown to the customer for selecting rules and selecting whether each rule is a hard or soft rule are the same for each of the customer's accounts at the financial institution 302 (e.g., are the same as interface 300). In other embodiments, the interfaces shown to the customer differ based on the type of account for which the customer is making the selections (e.g., are different for checking accounts versus credit accounts).

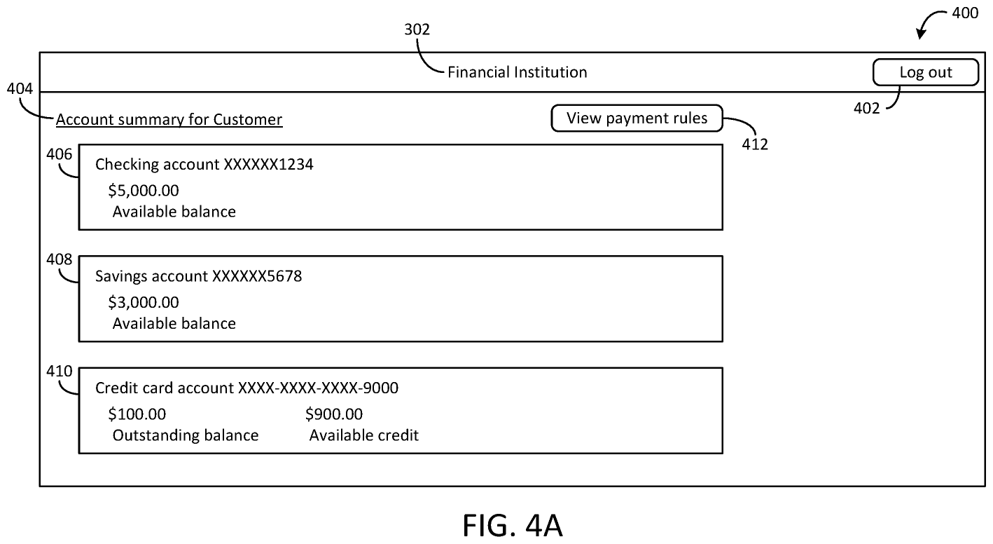

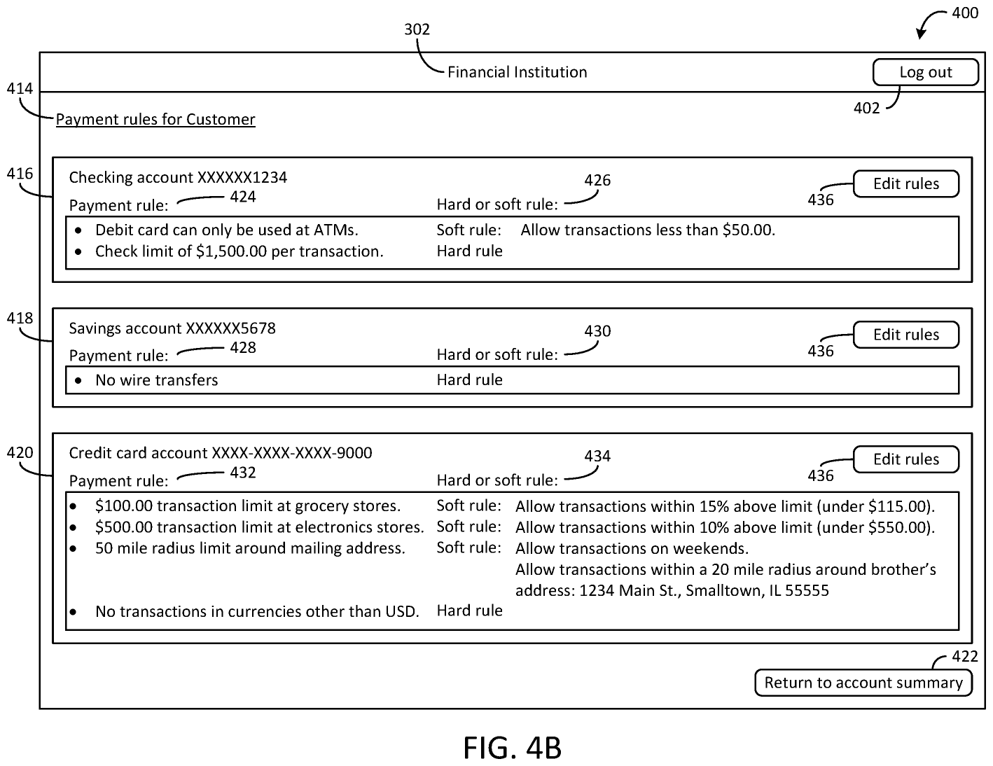

Referring now to FIGS. 4A and 4B, an interface 400 shown on a display of a computing device (e.g., on the display 120 of the customer device 102), including graphics displaying a customer profile (e.g., the customer profile set up by the customer as shown in FIGS. 3A and 3B), is shown according to an example embodiment. As shown, the interface 400 is also provided by the financial institution 302. Further, in the example of FIGS. 4A and 4B, the customer has again logged into a computing system associated with the financial institution 302 (e.g., a website or banking application associated with the financial institution 302), as shown by a button 402 indicating that the customer can “log out” of the computing system.

In FIG. 4A, the interface 400 displays a screen 404 showing an account summary for the customer. The account summary screen 404 includes a section 406 showing part of an account number and an account balance for a checking account held by the customer (e.g., the checking account from FIGS. 3A and 3B) and a section 408 showing part of an account number and an account balance for a savings account held by the customer. The account summary screen 404 also includes a section 410 showing part of a credit card number, an outstanding balance, and available credit for a credit card account held by the customer. The account summary screen 404 further includes a “View payment rules” button 412 that the customer can press to view the payment rules the customer has set up for each of the customer's accounts. For example, if the customer presses the button 412, the customer is directed to the interface 400 shown in FIG. 4B.

In FIG. 4B, the interface 400 displays a screen 414 showing payment rules for the accounts held by the customer (e.g., the accounts shown in sections 406, 408, and 410 of FIG. 4A). The payment rules screen 414 includes a checking account rules section 416 showing the payment rules for the customer's checking account (e.g., as set up in FIGS. 3A and 3B), a savings account rules section 418 showing payment rules for the customer's savings account, and a credit card account rules section 420 showing payment rules for the customer's credit card account. The payment rules screen 414 also includes a “Return to account summary” button 422 that the customer can press to return to the account summary screen 404 (e.g., as shown in FIG. 4A).

As shown in FIG. 4B, each of the sections 416, 418, and 420 includes (a) the payment rules set up for the respective account, (b) whether each rule is a hard rule or a soft rule, and (c) if the rule is a soft rule, criteria the customer has set up for the rule defining when a violating transaction should be considered low risk. Accordingly, looking first to the checking account rules section 416, the section 416 includes a subsection 424 showing the checking account payment rules and a subsection 426 showing the hard or soft rule status of each checking account payment rule. In the example of FIG. 4B, the checking account payment rules subsection 424 includes the rules set up by the customer as shown in FIGS. 3A and 3B. As such, the subsection 424 includes two rules: (1) “Debit card can only be used at ATMs” and (2) “Check limit of $1,500.00 per transaction.” Similarly, the checking account hard/soft rule subsection 426 shows that the debit card rule is a soft rule, with low risk transactions defined as transactions less than $50.00, and that the check limit rule is a hard rule.

Looking next to the savings account rules section 418, the section 418 includes a subsection 428 showing savings account rules set up by the customer for the savings account and a subsection 430 showing the hard or soft rule status of each savings account rule. In the example of FIG. 4B, the customer has created (e.g., in a process similar to that shown in FIG. 3A) only one rule for the customer's savings account: “No wire transfers.” Additionally, as shown in subsection 430, the customer has indicated (e.g., in a process similar to that shown in FIG. 3B) that this rule is a hard rule.

Finally, looking to the credit card account rules section 420, the section 420 includes a subsection 432 showing credit card account rules set up by the customer for the credit card account and a subsection 434 showing the hard or soft rule status of each credit card account rule. In the example of FIG. 4B, the customer has created four rules for the customer's credit card account: (1) “$100.00 transaction limit at grocery stores”; (2) “$500.00 transaction limit at electronics stores”; (3) “50 mile radius limit around mailing address”; and (4) “No transactions in currencies other than USD.” Subsection 434 shows that the first three rules are soft rules and that the fourth rule is a hard rule. Additionally, subsection 434 shows what transactions the customer has defined as low risk transactions for each soft credit card account rule. For the $100.00 transaction limit at grocery stores rule, the customer has defined low risk transactions as transactions within 15% over the $100.00 limit (i.e., transactions under $115.00). For the $500.00 transaction limit at electronics stores rule, the customer has defined low risk transactions as transactions within 10% over the $500.00 limit (i.e., transactions under $550.00). Finally, for the 50 mile radius limit around the customer's mailing address rule, the customer has defined low risk transactions as (a) transactions occurring on weekends and (b) transactions within a 20 mile radius around the customer's brother's address.

As shown in FIG. 4B, each section 416, 418, and 420 includes an “Edit rules” button 436. As such, the customer can press the button 436 in the account section 416, 418, or 420 for which the customer wishes to change the account rules. In various arrangements, by pressing the button 436, the customer is redirected to one or more rules editing screens (e.g., resembling FIGS. 3A and 3B).

Those of skill in the art will appreciate, however, that FIGS. 3A and 3B and FIGS. 4A and 4B illustrate example embodiments of graphical user interfaces presented to a customer as part of the customer profile setup and viewing process. Moreover, in certain embodiments, additional or alternative graphical user interfaces are presented to the user as part of the customer profile setup process and/or to allow the customer to view a customer profile, including payment rules, that the customer has previously created. For example, in some embodiments, graphical user interfaces presented to the customer as part of the profile setup process include sections for the customer to indicate whether the financial institution computing system 106 should automatically update payment rules, provide suggestions to the customer for updating payment rules, or do nothing when transactions violate soft and/or hard rules but are later authorized by the customer.

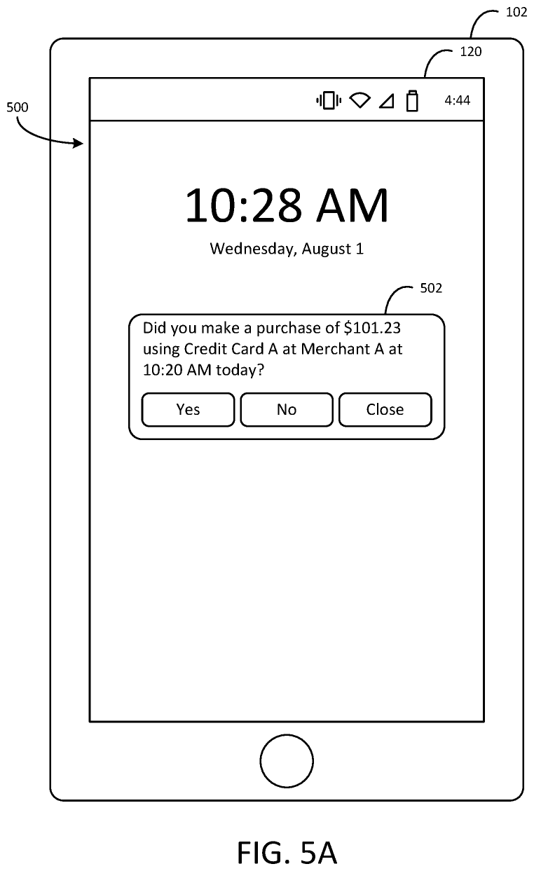

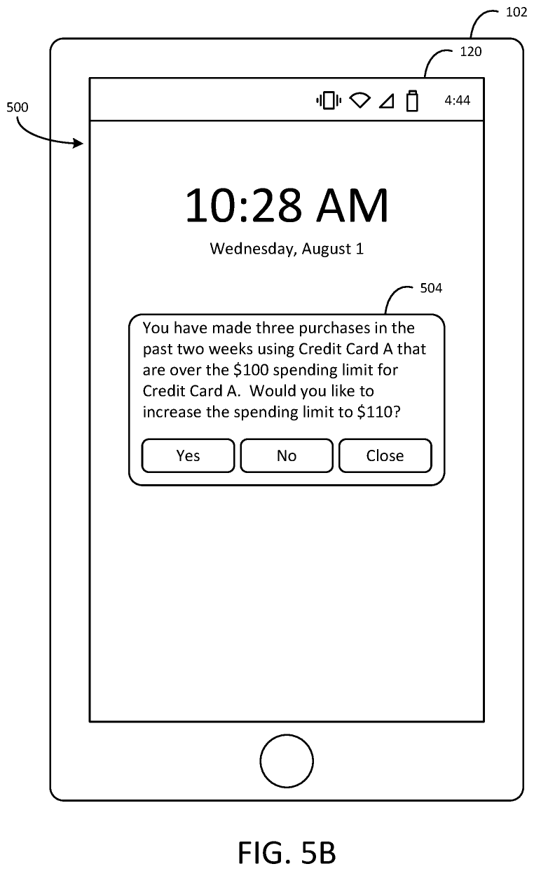

Referring now to FIGS. 5A and 5B, an interface 500 shown on a display of a mobile device is illustrated according to an example embodiment. As shown, in FIGS. 5A and 5B, the customer device 102 is a mobile device, and the display 120 is a screen of the mobile device. In FIG. 5A, the interface 500 notifies the customer that a low risk transaction violating a soft rule for one of the customer's accounts has occurred. More specifically, the interface 500 displays a push notification 502 asking the customer whether the customer made a specific purchase for $101.23 using the customer's Credit Card A (e.g., because the customer has a soft rule with a purchase limit of $100 for Credit Card A). The push notification 502 includes a “Yes” button that the customer can press to indicate that the customer is responsible for the transaction and a “No” button that the customer can press to indicate that the customer is not responsible for the transaction. For example, if the customer presses the “Yes” button, the financial institution computing system 106 allows the charge to post to the customer's account for Credit Card A. Conversely, if the customer presses the “No” button, the financial institution computing system 106 prevents the charge from posting to the customer's account for Credit Card A and instead charges the transaction back to Merchant A.

As discussed above, in various embodiments, in response to the customer indicating that the customer is responsible for a transaction that violates a soft rule, the financial institution computing system 106 determines whether the soft rule should be updated to avoid similar future transactions from violating the soft rule and thereby being flagged as potentially fraudulent. Accordingly, if the customer presses the “Yes” button in the push notification 502, the interface 500 recommends modifying the soft rule for Credit Card A, as shown in FIG. 5B. More particularly, the interface 500 displays a second push notification 504 informing the customer that the customer has made three purchases in the past two weeks using Credit Card A that are over the $100 spending limit for Credit Card A (e.g., the soft rule for Credit Card A). The second push notification 504 further asks the customer whether the customer would like to increase the spending limit (e.g., modify the soft rule) to $110. Similar to the push notification 502, the push notification 504 includes a “Yes” button that the customer can press to approve of the recommended spending limit modification and a “No” button that the customer can press to deny the recommended spending limit modification.

However, it should be understood that FIGS. 5A and 5B illustrate example embodiments of graphical user interfaces presented to the customer to allow the customer to approve transactions that violate the customer's configured rules and approve recommended rule updates. In other embodiments, different graphical user interfaces are used or graphical user interfaces are not needed (e.g., the financial institution computing system 106 makes an automated phone call to the customer asking the customer to approve of the transaction, the financial institution computing system 106 automatically updates the rule).

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on.

The “circuit” may also include one or more processors communicatively coupled to one or more memories or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be understood that a “network interface circuit,” as used herein, includes any of a cellular transceiver Code Division Multiple Access (CDMA), Global System for Mobile Communications (GSM), Long-Term Evolution (LTE), etc.), a wireless network transceiver (e.g., 802.11X, ZigBee, or Bluetooth), or a combination thereof (e.g., both a cellular transceiver and a Bluetooth transceiver). In some arrangements, a network interface circuit includes hardware and machine-readable media sufficient to support communication over multiple channels of data communication. Further, in some arrangements, the network interface circuit includes cryptography capabilities to establish a secure or relatively secure communication session between the device including the network interface and other devices of the environment 100 via the network 110. In this regard, personal information about clients, financial data, and other types of data is encrypted and transmitted to prevent or substantially prevent the threat of hacking.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps, and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions, and arrangement of the embodiments without departing from the scope of the present disclosure as expressed in the appended claims.

1. A method performed by a financial institution computing system of a financial institution, the method comprising:
receiving, by the financial institution computing system, via a graphic interface of an application executing on a customer device of a customer, one or more rules specified by the customer, the one or more rules comprising:
a first rule restricting future electronic transactions that satisfy a first criterion by exceeding a first limitation, and an indication that the first rule is an inflexible hard rule, and
a second rule restricting future electronic transactions that satisfy a second criterion by exceeding a second limitation, the second rule associated with a low risk threshold and including an indication that the second rule is a flexible soft rule;
receiving, by the financial institution computing system, from a first financial transaction computing system, a first payment request for a first electronic financial transaction involving an account held by the customer at the financial institution;
determining, by the financial institution computing system, that the first electronic financial transaction does not violate the hard rule by comparing first information of the first electronic financial transaction to the first limitation identified by the first criterion;
determining, by the financial institution computing system, that the first electronic financial transaction does violate the soft rule by determining that second information of the first electronic financial transaction exceeds the second limitation identified by the second criterion;
in response to determining that the first electronic financial transaction does not violate the hard rule but does violate the soft rule, determining, by the financial institution computing system, via fraud detection logic of a transaction processing circuit of the financial institution computing system, that the first electronic financial transaction is a low risk electronic transaction by determining that the second information does not exceed the second limitation by more than the low risk threshold identified by the second criterion;
in response to determining, by the fraud detection logic of the transaction processing circuit, that the first electronic financial transaction is the low risk electronic transaction, determining, by the financial institution computing system, that the soft rule should be updated by determining that the soft rule has been violated greater than a predetermined number of times over a predetermined time period;
automatically applying, by the financial institution computing system responsive to determining that the soft rule should be updated, an update to the soft rule by increasing the second limitation by a predetermined adjustment factor;
transmitting, by the financial institution computing system, a notification to the customer device comprising an indication that the soft rule has been automatically updated;
receiving at the financial institution computing system, from a second financial transaction computing system, a second payment request for a second electronic financial transaction involving the account;
determining, by the financial institution computing system, that the second electronic financial transaction does not violate the hard rule by comparing the first information of the second electronic financial transaction to the first limitation identified by the first criterion;
determining, by the financial institution computing system, that the second electronic financial transaction violates the updated soft rule by determining that the second information of the second electronic financial transaction exceeds the updated second limitation; and
in response to determining that the second electronic financial transaction violates the updated soft rule, declining, by the financial institution computing system, the second electronic financial transaction with the second financial transaction computing system.

2. The method of claim 1, further comprising:
transmitting, by the financial institution computing system to the customer device, a notification to the customer device asking the customer whether the customer was responsible for a payment request; and
in response to receiving an indication from the customer device that the customer was not responsible for the payment request, preventing, by the financial institution computing system, a payment from posting to the account.

3. The method of claim 1, further comprising receiving, by the financial institution computing system, one or more additional rules from the customer device and receiving, by the financial institution computing system, an indication from the customer device of whether each rule is a hard or a soft rule.

4. The method of claim 3, further comprising receiving, by the financial institution computing system from the customer device, further criteria defining the low risk electronic transaction for each soft rule, wherein determining whether the first electronic financial transaction is the low risk electronic transaction is based at least partially on the further criteria of the soft rule.

5. (canceled)

6. The method of claim 1, wherein one of the first rule or the second rule is:
a rule restricting devices that can be used to make a payment using the account;
a rule restricting payment methods that can be used to make a payment using the account;
a rule restricting financial transactions that can be carried out using a payment card associated with the account;
a rule restricting which merchants payments can be made to from the account;
a rule restricting a payment amount that can be made from the account;
a rule restricting currencies in which payments can be made from the account;
a rule defining geographic limitations on payments made from the account; or
a rule restricting products or services payments can be made for from the account.

7-8. (canceled)

9. A financial institution computing system of a financial institution, the financial institution computing system comprising:
a network interface;
an accounts database configured to store account information for a plurality of customers of the financial institution; and
one or more processors configured for:
receiving, via a graphic interface of an application executing on a customer device of a customer, one or more rules specified by the customer, the one or more rules comprising:
a first rule restricting future electronic transactions that satisfy a first criterion by exceeding a first limitation, and an indication that the first rule is an inflexible hard rule, and
a second rule restricting future electronic transactions that satisfy a second criterion by exceeding a second limitation, the second rule associated with a low risk threshold and including an indication that the second rule is a flexible soft rule;
receiving, from a financial transaction computing system via the network interface, a first payment request for a first electronic financial transaction, the first payment request associated with an account held by the customer at the financial institution;
determining that the first electronic financial transaction does not violate the hard rule by comparing first information of the first electronic financial transaction to the first limitation identified by the first criterion;
determining that the first electronic financial transaction does violate the soft rule by determining that second information of the first electronic financial transaction exceeds the second limitation identified by the second criterion;
in response to determining that the first electronic financial transaction does not violate the hard rule but does violate the soft rule, determining, via fraud detection logic of a transaction processing circuit of the financial institution computing system, that the first electronic financial transaction is a low risk electronic transaction by determining that the second information does not exceed the second limitation by more than the low risk threshold identified by the second criterion;
in response to determining, via the fraud detection logic of the transaction processing circuit, that the first electronic financial transaction is the low risk electronic transaction, determining that the soft rule should be updated by determining that the soft rule has been violated greater than a predetermined number of times over a predetermined time period;
automatically applying, responsive to determining that the soft rule should be updated, an update to the soft rule by increasing the second limitation by a predetermined adjustment factor;
transmitting, via the network interface, a notification to the customer device comprising an indication that the soft rule has been automatically updated;
receiving, via the network interface, from a second financial transaction computing system, a second payment request for a second electronic financial transaction involving the account;
determining that the second electronic financial transaction does not violate the hard rule by comparing the first information of the second electronic financial transaction to the first limitation identified by the first criterion;
determining that the second electronic financial transaction violates the updated soft rule by determining that the second information of the second electronic financial transaction exceeds the updated second limitation identified by the second criterion; and
in response to determining that the second electronic financial transaction violates the updated soft rule, declining the second electronic financial transaction.

10. The financial institution computing system of claim 9, wherein the one or more processors are further configured for:
transmitting a notification to the customer device asking the customer whether the customer was responsible for a payment request; and
in response to receiving an indication from the customer device that the customer was not responsible for the payment request, preventing a payment from posting to the account.

11. The financial institution computing system of claim 9, wherein the one or more processors are further configured for receiving one or more additional rules from the customer device and receiving an indication from the customer device of whether each rule is a hard or a soft rule.

12. The financial institution computing system of claim 11, wherein the one or more processors are further configured for receiving, from the customer device, criteria defining the low risk electronic transaction for each soft rule, and wherein the one or more processors are further configured for determining whether the first electronic financial transaction is the low risk electronic transaction based at least partially on the criteria for the violated soft rule.

13. (canceled)

14. The system of claim 9, wherein one of the first rule or the second rule is:
a rule restricting devices that can be used to make a payment using the account;
a rule restricting payment methods that can be used to make a payment using the account;
a rule restricting financial transactions that can be carried out using a payment card associated with the account;
a rule restricting which merchants payments can be made to from the account;
a rule restricting a payment amount that can be made from the account;
a rule restricting currencies in which payments can be made from the account;
a rule defining geographic limitations on payments made from the account; or
a rule restricting products or services payments can be made for from the account.

15-16. (canceled)

17. A non-transitory computer-readable medium having instructions encoded thereon which, when executed by one or more processors of a computing system, cause the one or more processors of the computing system to perform a method comprising:
receiving, via a graphic interface of an application executing on a customer device of a customer of a financial institution associated with the computing system, one or more rules specified by the customer, the one or more rules comprising a first rule restricting future electronic transactions that satisfy a first criterion by exceeding a first limitation, and a second rule restricting future electronic transactions that satisfy a second criterion by exceeding a second limitation;
receiving, via the graphic interface of the application executing on the customer device, an indication from the customer that the first rule is an inflexible hard rule and an indication that the second rule is a flexible soft rule and is associated with a low risk threshold;
receiving, from a financial transaction computing system, a first payment request for first electronic financial transaction involving a financial account of the customer;
determining that the first electronic financial transaction does not violate the hard rule by comparing first information of the first electronic financial transaction to the first limitation identified by the first criterion;
determining that the first electronic financial transaction does violate the soft rule by determining that second information of the first electronic financial transaction exceeds the second limitation identified by the second criterion;
in response to determining that the first electronic financial transaction does not violate the hard rule but does violate the soft rule, determining, via a fraud detection logic of a transaction processing circuit of the computing system, that the first electronic financial transaction is a low risk electronic transaction by determining that the second information does not exceed the second limitation by more than the low risk threshold identified by the second criterion;
in response to determining, by the fraud detection logic of the transaction processing circuit, that the first electronic financial transaction is the low risk electronic transaction:
determining that the soft rule should be updated by determining that the soft rule has been violated greater than a predetermined number of times over a predetermined time period;
automatically applying, responsive to determining that the soft rule should be updated, an update to the soft rule by increasing the second limitation by a predetermined adjustment factor;
transmitting a notification to the customer device comprising an indication that the soft rule has been automatically updated;
authorizing the first electronic financial transaction for the first electronic financial transaction with the computing system;
receiving, from a second computing system, a second payment request for a second electronic financial transaction involving the financial account of the customer;
determining that the second electronic financial transaction does not violate the hard rule by comparing the first information of the second electronic financial transaction to the first limitation identified by the first criterion;
determining that the second electronic financial transaction violates the updated soft rule by determining that the second information of the second electronic financial transaction exceeds the updated second limitation; and
in response to determining that the second electronic financial transaction violates the updated soft rule, declining the second electronic financial transaction.

18. The non-transitory computer-readable medium of claim 17, wherein the method further comprises:
transmitting a notification to the customer device asking the customer whether the customer was responsible for a payment request; and
in response to receiving an indication from the customer device that the customer was not responsible for the payment request, preventing a payment from posting to the financial account.

19-20. (canceled)
